(19) United States
(12) Patent Application Publication
(10) Pub. No.: US 2002/0081902 A1
(43) Pub. Date: Jun. 27, 2002

(54) Electrical connector having improved performance regarding resistance to high voltage penetration

(76) Inventors: Guohua Zhang, Kunsan (CN); ZiQiang Zhu, Kunsan (CN); Jinkui Hu, Kunsan (CN)

Correspondence Address: Wei Te (Joseph) Chung, Foxconn International, Inc., 1650 Memorex Drive, Santa Clara, CA, 95050, US

(21) Appl. No.: 10/028,567

(22) Filed: Dec. 20, 2001

(30) Foreign Application Priority Data
Dec. 21, 2000 (TW) 89222271

(51) Int. Cl. H01R 13/648

(52) U.S. Cl. 439/607

(57) ABSTRACT

An electrical connector (1) comprises an insulating housing (10) defining first and second receiving slots (12, 14) receiving first and second terminal inserts (23, 25), respectively. A plurality of first and second terminals (22, 24) are insert molded with the first and second terminal inserts. The first and second terminals include contact portions (22b, 24b), solder portions (22c, 24c), and arcuate portions (22a, 24a) between the solder portions and the arcuate portions. A shield (40) comprises a top wall (42) tightly enclosing a top surface (10c) of the housing. The top wall defines an opening (42a) at a position below which the arcuate portions of the first terminals are arranged, thereby preventing the first terminals from being damaged by high electrostatic charge.

### BACKGROUND OF THE INVENTION

1. Field of the Invention

The present invention relates to an electrical connector, and particularly to an electrical connector with improved high voltage penetration resisting performance.

2. Description of Related Art

Referring to FIG. 5, a conventional electrical connector comprises an insulating housing 60 defining first and second receiving slots 62 and 64 to receive first and second terminal inserts 70 and 72 therein, respectively. A plurality of terminals 71 and 73 are insert molded with the terminal inserts 70 and 72, respectively. Two board locks 66 are secured to the housing 60 to fix the connector to a printed circuit board. A shield 90 is attached on the housing 60 to shield the housing 60 and the terminals 71 and 73. However, to such a mini-type connector, a minimum distance between a top wall 92 of the shield 90 and exposed arcuate portions 71a of the terminals 71 is only about 0.3 mm which does not fit the industry standard (not less than 2.5 mm). It is well known that a good performance in resisting high voltage penetration is essential to the reliability of the connector. However, such a conventional design is apt to cause electrical current flowing from the shield 90 to the terminals 71 when a high voltage (1500 V) is applied to the shield 90, resulting in a failure of the connector. To resolve the problem, the shield is relocated to be far away from the terminals to increase the distance therebetween. However, this causes the connector to be too bulky to be accepted by the industry.

### SUMMARY OF THE INVENTION

Accordingly, the object of the present invention is to provide an electrical connector having improved high voltage penetration resisting performance.

To fulfill the above-mentioned object, an electrical connector of the present invention comprises an insulating housing and a shield having a top wall shielding a top surface of the housing. The housing defines first and second receiving slots receiving first and second terminal inserts therein, respectively. A plurality of first and second terminals are insert molded with the first and second terminal inserts, respectively. The terminals include contact portions, solder portions and arcuate portions between the contact portions and the solder portions. The arcuate portions of the terminals are directly exposed to the top wall of the shield. The top wall of the shield defines an opening at a position below which the arcuate portions of the terminals are arranged, thereby increasing a minimum distance between the top wall of the shield and the arcuate portions of the terminals to prevent the terminals from being damaged by high electrostatic charge.

Other objects, advantages and novel features of the invention will become more apparent from the following detailed description of the preferred embodiment when taken in conjunction with the accompanying drawings.

### BRIEF DESCRIPTION OF THE DRAWINGS

FIG. 1 is an exploded view of an electrical connector of the present invention;

FIG. 2 is an assembled view of the electrical connector of FIG. 1;

FIG. 3 is a perspective view of a shield of a second embodiment of the present invention;

FIG. 4 is a perspective view of a shield of a third embodiment of the present invention; and

FIG. 5 is an exploded view of a conventional electrical connector.

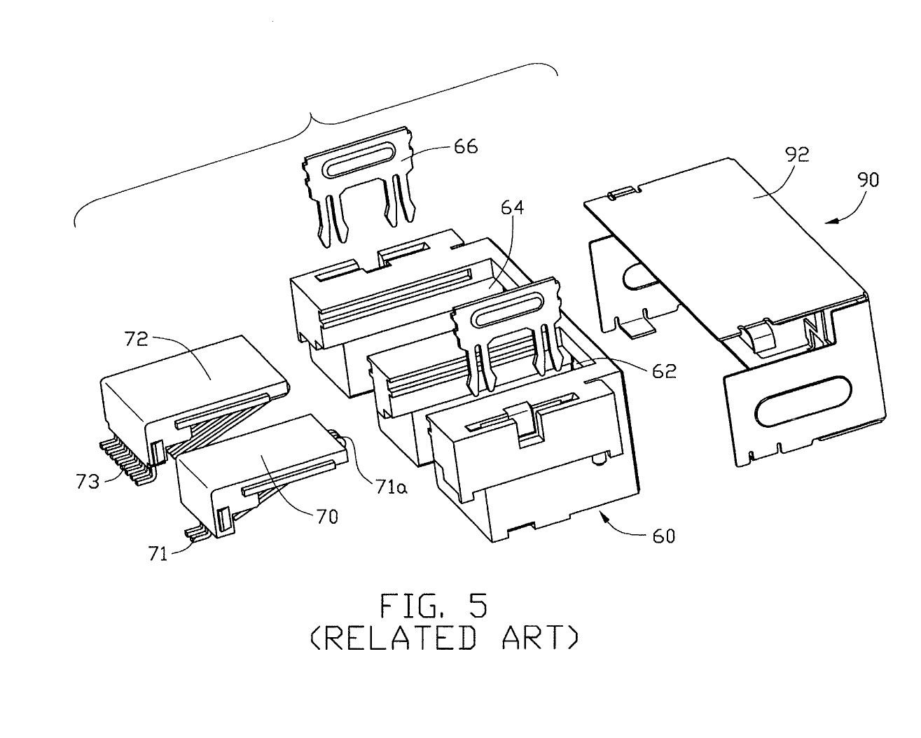

### DETAILED DESCRIPTION OF THE INVENTION

Reference will now be made to the drawing figures to describe the present invention in detail.

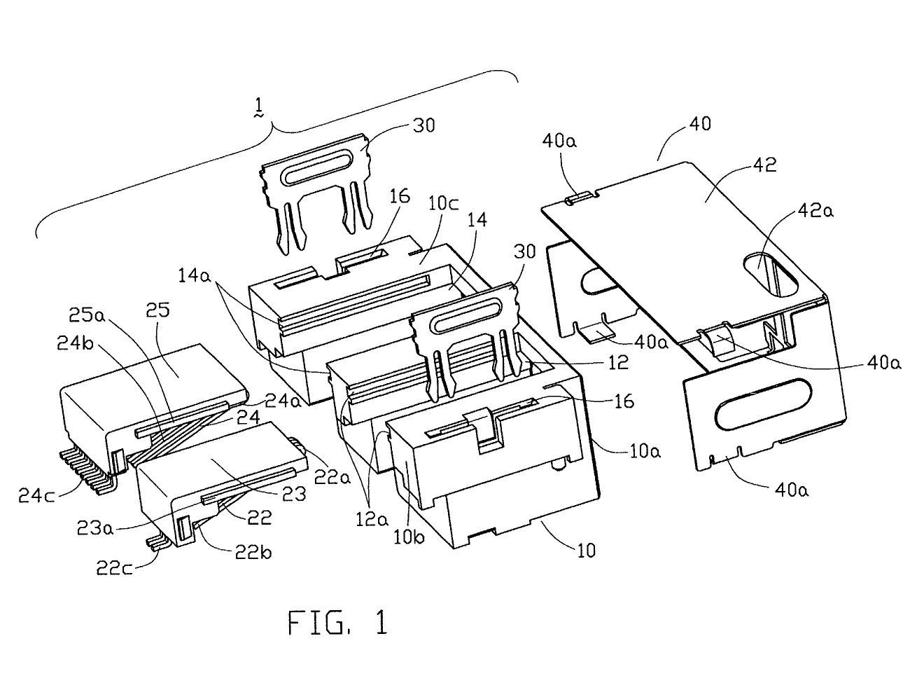

Referring to FIG. 1, an electrical connector 1 of the present invention includes an elongated insulating housing 10 receiving first and second terminal inserts 23 and 25 therein, a pair of slits 16 beside the terminal inserts 23 and 25 receiving a pair of board locks 30 therein, and a shield 40 shielding the housing 10.

The housing 10 defines first and second receiving slots 12 and 14, and two pair of guide channels 12a and 14a in the receiving slots 12 and 14. The terminal inserts 23 and 25 define two pair of guide posts 23a and 25a corresponding to guide channels 12a and 14a of the housing 10.

A plurality of first and second terminals 22 and 24 are insert molded with the terminal inserts 23 and 25, respectively. The terminals 22 and 24 include solder portions 22c and 24c to be soldered to a printed circuit board (not shown), contact portions 22b and 24b for contacting mating terminals (not shown), and arcuate portions 22a and 24a between the solder portions 22c, 24c and the contact portions 22b, 24b. The arcuate portions 22a and 24a extend beyond front ends of the terminal inserts 23 and 25 and exposed to the shield 40.

The shield 40 comprises a top wall 42 enclosing a top surface 10c of the housing 10 and a plurality of securing portions 40a engaged to the housing 10. The top wall 42 defines an opening 42a at a position below which the arcuate portions 22a of the first terminals 22 are arranged. The opening 42a allows a minimum distance between the arcuate portions 22a and the top wall 42 of the shield 40 to be not less than 2.5 mm which is required by certain industry standard, thereby preventing the first terminals 22 from being damaged by high electrostatic charge.

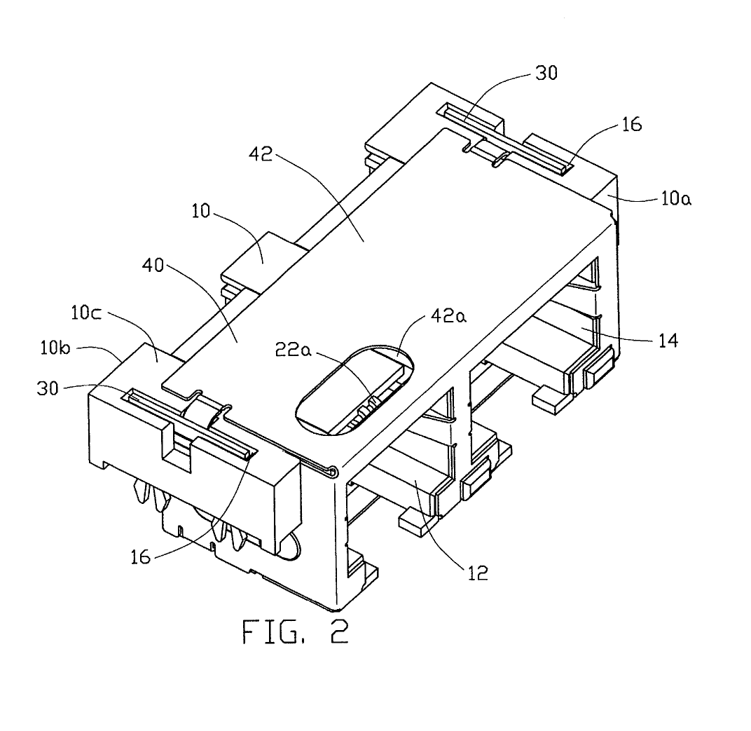

Also referring to FIG. 2, in assembly, the terminal inserts 23 and 25 with the terminals 22 and 24 are respectively inserted into corresponding receiving slots 12 and 14 from a rear surface 10b of the housing 10 by guiding the guide posts 23a and 25a into guide channels 12a and 14a of the housing 10. The pair of locks 30 are inserted into the slits 16 from the top surface 10c of the housing 10. The shield 40 is then assembled to the housing 10 from a front surface 10a by properly positioning the opening 42a of the top wall 42 over the arcuate portions 22a of the first terminals 22.

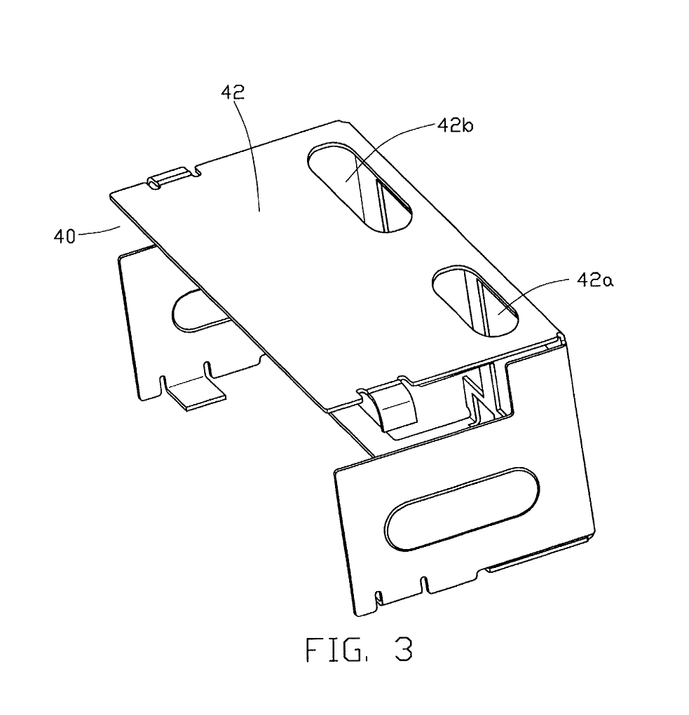

FIG. 3 shows a shield of a second embodiment of the present invention. It differs from the first embodiment in that the top wall 42 of the shield 40 also defines an opening 42b over the arcuate portions 24a of the second terminals 24. The opening 42b performs similar function to the opening 42a so that it will not be detailed here.

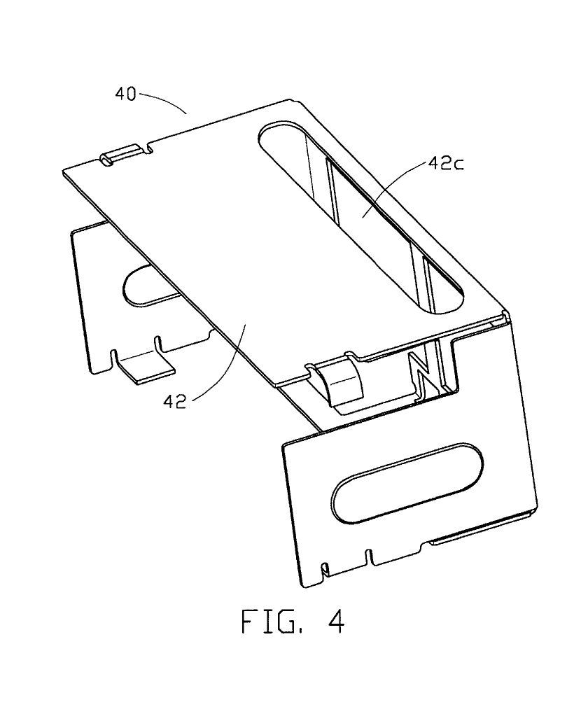

Referring to FIG. 4, a shield of the third embodiment of the present invention defines a large opening 42c encompassing otherwise present openings 42a and 42b to benefit a manufacturing process.

An advantage of the present invention is that the distance between the arcuate portions of the terminals and the shield is not less than 2.5 mm thereby meeting the industry standard.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulating housing defining a first receiving slot at a rear surface thereof and opening at a top surface thereof;
a plurality of first terminals insert molded with a first insulating terminal insert received within the first receiving slot, each first terminal comprising a solder portion to be soldered to a printed circuit board, a contact portion for contacting with a mating terminal, and an arcuate portion between the solder portion and the contact portion and exposed to the top surface of the housing; and
a shield comprising a plurality of securing portions engaged to an outer side of the housing, and a top wall enclosing the top surface of the housing, the top wall defining an opening at a position below which the arcuate portions of the first terminals are arranged.

2. The electrical connector as claimed in claim 1, wherein a minimum distance between the arcuate portions of the first terminals and the shield is not less than 2.5 mm.

3. The electrical connector as claimed in claim 1, wherein the housing further comprises a second receiving slot receiving a plurality of second terminals insert molded with a second insulating terminal insert, each second terminal including a solder portion, a contact portion and an arcuate portion, the arcuate portion being exposed to the top surface of the housing.

4. The electrical connector as claimed in claim 3, wherein an opening is defined at a position below which the arcuate portions of the second terminals are arranged.

5. The electrical connector as claimed in claim 4, wherein the openings over the arcuate portions of the first and second terminals constitute a part of a large opening.

6. An electrical connector comprising:
an insulating housing defining a receiving slot and a pair of slits beside the receiving slot thereof;
a shield assembled to the housing from a front surface thereof and at least enclosing a top surface of the housing, the shield including a plurality of securing portions engaged to the housing; and
a plurality of terminals insert molded with an insulating terminal insert received within the receiving slot from a rear surface of the housing, at least one of the terminals having a portion exposed to the shield; and
a pair of board locks secured into the slits from the top surface of the housing to secure the connector to a printed circuit board;
wherein the shield defines an opening over the portion of the terminal and a minimum distance between the portion of the terminal and the shield is not less than 2.5 mm.

7. An electrical connector comprising:
an insulative housing defining a receiving slot therein;
a terminal insert disposed in said housing with laterally juxtaposed terminals extending into said receiving slot, said terminals defining actuate portions located around a front portion of a horizontal face of the housing where said receiving slot is open to an exterior in a vertical direction; and
a metallic shield enclosing said housing with an elongated opening in a front portion of a horizontal wall thereof adjacent to said actuate portions, said horizontal wall, except said elongated opening, essentially covering said horizontal face; wherein
said elongated opening extends along said laterally juxtaposed actuation portions, and said actuation portions are visible through said elongated opening in said vertical direction.
